(19) United States
(12) Patent Application Publication
(10) Pub. No.: US 2023/0180000 A1
(43) Pub. Date: Jun. 8, 2023

(54) METHOD AND APPARATUS FOR TRANSMITTING AND RECEIVING INFORMATION RELATED TO USER EQUIPMENT IN WIRELESS COMMUNICATION SYSTEM

(71) Applicant: Samsung Electronics Co., Ltd., Gyeonggi-do (KR)

(72) Inventors: Duckey LEE, Gyeonggi-do (KR); Jungje SON, Gyeonggi-do (KR); Taehyung LIM, Gyeonggi-do (KR); Hongjin CHOI, Gyeonggi-do (KR)

(21) Appl. No.: 18/076,678

(22) Filed: Dec. 7, 2022

(30) Foreign Application Priority Data
Dec. 7, 2021 (KR) 10-2021-0174144

(51) Int. Cl. H04W 12/06; H04L 9/32

(52) U.S. Cl. CPC H04W 12/06; H04L 9/3213

(57) ABSTRACT

The disclosure relates to a 5^{th} generation (5G) or pre-5G communication system for supporting a higher data rate than a beyond 4^{th} generation (4G) communication system such as long term evolution (LTE). A user equipment (UE) in a wireless communication system may include a transceiver and at least one controller controlling the transceiver. The at least one controller may be configured to configure a first encryption key with a network according to a primary authentication procedure, receive a first message requesting permission for use of information about the UE from an application function device, determine whether to allow use of the information about the UE based on reception of the message, generate a token based on at least one of the first encryption key, an identifier (ID) of the UE, or a first input value based on determining to allow use of the information about the UE, and transmit a second message indicating permission for use of the information about the UE, including the token to the application function device in response to the first message.

### CROSS-REFERENCE TO RELATED APPLICATION(S)

This application is based on and claims priority under 35 U.S.C. §119 to Korean Patent Application No. 10-2021-0174144, filed on Dec. 7, 2021, in the Korean Intellectual Property Office, the disclosure of which is incorporated herein by reference in its entirety.

### BACKGROUND

### 1. Field

The disclosure relates to a method and apparatus for transmitting and receiving user equipment (UE)-related information in a wireless communication system.

### 2. Description of Related Art

In order to meet the soaring demand for wireless data traffic since the 4^{th} generation (4G) communication system came to the market, there are ongoing efforts to develop enhanced 5^{th} generation (5G) communication systems or pre-5G communication systems. For at least these reasons, the 5G communication system or pre-5G communication system is called the beyond 4G network communication system or post LTE system.

For higher data transmission rates, 5G communication systems are considered to be implemented on ultra-high frequency bands (mmWave), such as, e.g., 60 GHz. To mitigate pathloss on the ultra-high frequency band and increase the reach of radio waves, the following techniques are taken into account for the 5G communication system: beamforming, massive multi-input multi-output (mMIMO), full dimensional MIMO (FD-MIMO), array antenna, analog beamforming, and large scale antenna.

Also being developed are various technologies for the 5G communication system to have an enhanced network, such as evolved or advanced small cell, cloud radio access network (cloud RAN), ultra-dense network, device-to-device (D2D) communication, wireless backhaul, moving network, cooperative communication, coordinated multi-point (CoMP), and reception interference cancellation.

There are also other various schemes under development for the 5G system including, e.g., hybrid frequency shift keying (FSK) and quadrature amplitude modulation (QAM) modulation (FQAM) and sliding window superposition coding (SWSC), which are advanced coding modulation (ACM) schemes, and filter bank multi-carrier (FBMC), non-orthogonal multiple access (NOMA) and sparse code multiple access (SCMA), which are advanced access schemes.

### SUMMARY

Various services may be provided to a user equipment (UE). To provide optimal services to the UE according to the location or state of the UE, applications request to use UE information. The UE information should be strictly handled to protect a user’s privacy. Therefore, there is a need for methods of controlling to provide information about a UE to an application allowed by a user during a user-desired time period and not to provide the UE information likely to infringe the user’s privacy to an application not allowed by the user.

In order to strengthen the privacy protection of a user, there is a need for a method of, even when a user allows an application to use information about a UE, enabling the user to manage the authority of the application to use the UE information as desired, such as allowing the application only at a specific time, making the application request permission again after a period of time, or making the application request permission each time, when needed.

Further, methods of verifying whether an application requesting information about a UE has been allowed by a user in a mobile communication system (network or network device) are required. For these methods, methods of verifying whether the approval of the UE for use of UE information regarding a permission request from an application has been forged are required.

This disclosure provides a method and apparatus for transmitting and receiving UE-related information in a wireless communication system.

A method and apparatus are also provided for, when an application server connected to a UE and providing a service to the UE intends to obtain UE information in a wireless communication system, asking the UE whether the application server is allowed to obtain the UE information.

Additional aspects will be set forth in part in the description which follows and, in part, will be apparent from the description, or may be learned by practice of the presented embodiments of the disclosure.

According to an embodiment, a UE may receive a request for use of information about the UE in a network from an application. When a user accepts the request, the UE may issue, to the application, a token including information about an ID of the application, and information about the type of information about the UE that the user allows the application to access, a time of requesting permission, and a time at which the permission is valid. To prevent forgery of the application, the token may be encrypted, protected against forgery, or signed with an electronic signature through an encryption key pre-agreed or pre-shared with the network. Upon receipt of the token, the application or an application server may request information about the UE including the token from the network. Upon receipt of the request, the network may verify the request to identify whether the user has allowed use of the information about the UE, using the token included in the request from the application or the application server. When identifying that the request is authorized by the user and thus valid, the network may provide the information about the UE to the application or the application server.

According to an embodiment, a UE in a wireless communication system may include a transceiver and at least one controller controlling the transceiver. The at least one controller may be configured to configure a first encryption key with a network according to a primary authentication procedure, receive a message requesting permission for use of information about the UE from an application function device, determine whether to allow use of the information about the UE based on the reception of the message, generate a token based on at least one of the first encryption key, an identifier (ID) of the UE, or a first input value based on determining to allow use of the information about the UE, and transmit a message indicating permission for use of the information about the UE, including the token to the application function device in response to the message.

According to an embodiment, an application function device in a wireless communication system may include a transceiver and at least one controller controlling the transceiver. The at least one controller may be configured to transmit a message requesting permission for use of information about a UE to the UE, and receive a message indicating permission for use of the information about the UE, including a token from the UE in response to the message. The token may be generated based on at least one of a first encryption key, an ID of the UE, or a first input value. According to an embodiment, a network device in a wireless communication system may include a transceiver and at least one controller controlling the transceiver. The at least one controller may be configured to receive a message requesting information about a UE, including a token from an application function device, determine whether the token is valid based on at least one of a first encryption key, an ID of the UE, or a first input value, and transmit the information about the UE requested by the application function device to the application function device, based on determining the token as valid.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a network architecture of a 5^{th} generation (5G) wireless communication system, according to an embodiment;

FIG. 2 illustrates a signal flow for a procedure of issuing a token by a user equipment (UE) and obtaining UE information, using the token by an application server, according to an embodiment;

FIG. 3 illustrates a signal flow for a procedure of obtaining information about a UE, using a token in a network supporting an authentication and key management for applications (AKMA) function, according to an embodiment;

FIG. 4 illustrates a signal flow for a procedure of obtaining information about a UE, using a token in a network supporting an AKMA function, according to an embodiment;

FIG. 5 illustrates a method of generating an encryption key used to manage the privacy of a UE, according to an embodiment;

FIG. 6 illustrates a structure of a UE, according to an embodiment;

FIG. 7 illustrates a structure of an application function (AF) according to an embodiment; and

FIG. 8 illustrates a structure of a network device, according to an embodiment.

### DETAILED DESCRIPTION

Various embodiments of the disclosure are described below in detail with reference to the accompanying drawings. Further, to avoid obscuring the subject matter of the embodiments, a detailed description of related known functions or structures will be omitted in describing the embodiments of the disclosure. The terms described below are defined in consideration of functions in the embodiments, and may be changed according to the intention of a user or an operator, or according to custom. Accordingly, the definitions should be made by the meanings of each term lying within.

For the same reason, some components may be exaggerated, omitted, or schematically illustrated in the accompanying drawings. In addition, the drawn size of each component does not exactly reflect its real size. In each drawing, the same reference numerals are assigned to the same or corresponding components.

The advantages and features of the disclosure, and a method of achieving them will become apparent from reference to embodiments described below in detail in conjunction with the attached drawings. However, the disclosure may be implemented in various manners, not limited to the embodiments set forth herein. Rather, these embodiments are provided such that the disclosure is complete and thorough and its scope is fully conveyed to those skilled in the art, and the disclosure is only defined by the appended claims.

It will be understood that each block of the flowchart illustrations and block diagrams, and combinations of blocks in the flowchart illustrations and/or block diagrams can be implemented by computer program instructions. These computer program instructions may be loaded on a processor of a general purpose computer, special purpose computer, or other programmable data processing equipment, such that the instructions, which are executed via the processor of the computer or other programmable data processing equipment, create means for implementing the functions specified in the flowchart block(s). These computer program instructions may also be stored in a computer-usable or computer-readable memory that can direct the computer or other programmable data processing equipment to function in a particular manner, such that the instructions stored in the computer-usable or computer-readable memory produce an article of manufacture including instruction means which implement the function/act specified in the flowchart and/or block diagram block(s). The computer program instructions may also be loaded onto the computer or other programmable data processing equipment to cause a series of operations to be performed on the computer or other programmable data processing equipment to produce a computer implemented process such that the instructions which are executed on the computer or other programmable equipment provide operations for implementing the functions specified in the flowchart and/or block diagram block(s).

Furthermore, the respective block diagrams may illustrate parts of modules, segments, or codes including one or more executable instructions for performing specific logic function(s). Moreover, it should be noted that the functions of the blocks may be performed in a different order in several modifications. For example, two successive blocks may be performed at substantially the same time, or may be performed in reverse order according to their functions.

The term “unit” as used herein means, but is not limited to, a software or hardware component, such as a field programmable gate array (FPGA) or application specific integrated circuit (ASIC), which performs certain tasks. A unit may advantageously be configured to reside on an addressable storage medium and configured to be executed on one or more processors. Thus, a unit may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided in the components and “units” may be combined into fewer components and “units” or further separated into additional components and “units”. In addition, the components and “units” may be implemented such that they are executed on one or more central processing units (CPUs) in a device or a secure multimedia card.

Hereinbelow, a base station (BS), which is an entity to allocate resources to a user equipment (UE), may be at least one of a Node B, a evolved Node B (eNode B or eNB), a radio access network (RAN), an access network (AN), a RAN node, a new radio node B (NR NB), a next generation Node B (gNode B or gNB), a radio access unit, a base station controller (BSC), or a network node. A terminal may include a user equipment (UE), a mobile station (MS), a cellular phone, a smart phone, a computer, or a multimedia system capable of executing a communication function. In the disclosure, a downlink (DL) refers to a wireless transmission path for a signal that a BS transmits to a UE, and an uplink (UL) refers to a wireless transmission path for a signal that a UE transmits to a BS. While embodiments of the disclosure are described below in the context of a system based on long term evolution (LTE) or long term evolution-advanced (LTE-A) by way of example, they are also applicable to other communication systems having a similar technical background or channel structure. Further, the disclosure is also applicable to other communication systems with some modifications made without greatly departing from the scope of the disclosure as judged by those skilled in the art.

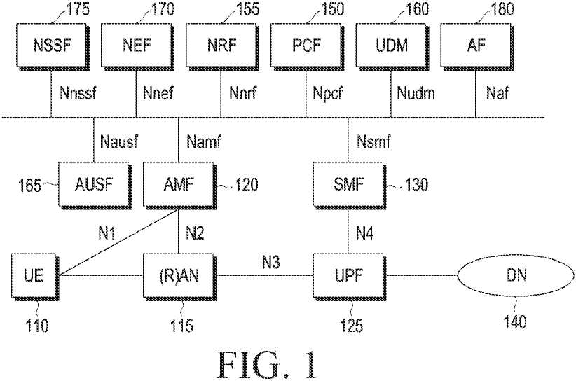

A unit that executes each function provided by a 5^{th} generation (5G) network system may be defined as a network function (NF). A structure of a 5G mobile communication network is illustrated in FIG. 1.

FIG. 1 illustrates a network architecture of a 5G system according to an embodiment of the disclosure.

Referring to FIG. 1, the network architecture may include at least one of an access and mobility management function (AMF) 120 managing network access and mobility of a UE 110, a session management function (SMF) 130 executing session-related functions for the UE 110, a user plane function (UPF) 125 responsible for transferring user data and controlled by the SMF 130, an application function (AF) 180 communicating with a 5G core (5GC) to provide application services, a network exposure function (NEF) 170 supporting communication with the AF 180, a unified data management (UDM) 160 or a unified data repository (UDR) that stores and manages data, a policy and control function (PCF) 150 managing a policy, or a data network (DN) 140 (e.g., the Internet) through which user data is transmitted. The AF 180 may be referred to as an application server or an application.

In addition to the above-described NFs, there may exist an operation, administration, and management (OAM) server, which is a system managing the UE 110 and a 5G mobile communication network. The 5G network system may further include a RAN (e.g., a BS) 115, an authentication server function (AUSF) 165, a network slice selection function (NSSF) 175, and a network repository function (NRF) 155.

When the network supports an authentication and key management for applications (AKMA) function, the network architecture may include an AKMA anchor function (AAnF).

In various embodiments, the AMF 120, the UPF 125, the SMF 130, the PCF 150, the NRF 155, the AUSF 165, the NEF 170, the NSSF 175, and the AF 180 may also be referred to as an AMF device 120, a UPF device 125, an SMF device 130, a PCF device 150, an NRF device 155, an AUSF device 165, an NEF device 170, an NSSF device 175, and an AF device 180, respectively.

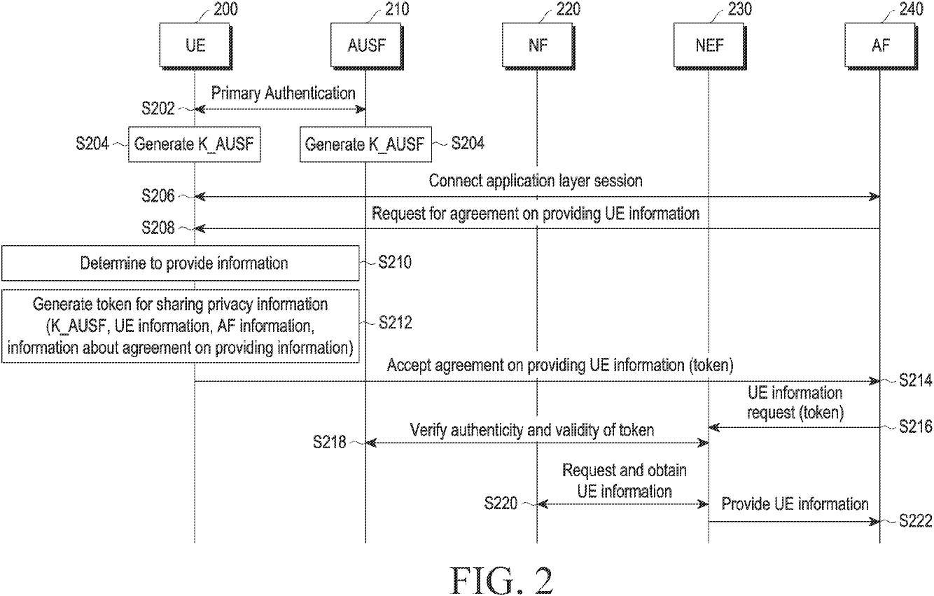

FIG. 2 illustrates a signal flow for a procedure of issuing a token by a UE and obtaining UE information, using the token by an application server, according to an embodiment.

After a UE 200 successfully completes authentication with a network, the UE 200 may share an encryption key for privacy verification, using an encryption key shared with an AUSF 210, and generate a token by which to verify a request from an AF 240 when the AF 240 requests UE information from the network. Upon receipt of the token, the AF 240 may attach the token to a message requesting the UE information from the network (e.g., an NEF or an NF), and an NEF 230 or an NF 220 may request the AUSF 210 to verify whether the token is correct. When verifying that the token is correct, the network may provide the requested UE information to the AF 240. The network may refer to an NF that includes UE information in advance. For example, the network may correspond to any of various NFs such as a UDM, an NEF, an AUSF, and a UDR.

The UE 200 performs a registration procedure for accessing the network in the mobile communication system. Herein, the AUSF 210 and the UE 200 perform a primary authentication procedure for authenticating to the network at S202. After succeeding in the primary authentication, the UE 200 and the AUSF 210 responsible for authentication in the network may generate the same encryption key, K_AUSF to be used later for security of the UE at S204.

The UE 200 may connect a session with the AF (hereinafter, application or application server) 240 to provide a service to a user at S206. The UE 200 and the application server 240 may be connected to each other, using a mobile communication system or another communication system. The UE 200 and the application server 240 may connect the session through a 3^{rd} generation partnership project (3GPP) or non-3GPP network.

When the application or application server 240 requires UE information to provide a service, it may request permission for use of the UE information from the UE 200 at S208. When the application or application server 240 needs UE information that the network has, it may request permission for use of UE information, inclusive of the UE information that the network has.

Upon receipt of the request for permission for use of the UE information from the application or application server 240, the UE 200 may determine whether to allow the information included in the request at S210. The UE 200 may use information about permission or non-permission that has been received from the user and stored to determine whether to allow use of the UE information. Alternatively, when the UE 200 needs to obtain permission for use of the UE information from the user, the UE 200 may ask the user whether to allow the use of the UE information. When the UE 200 asks the user whether to allow the use of the UE information, the UE 200 may ask the user, using the display of the UE 200. The UE 200 may use a user interface (UI) requesting permission from the user, or the application may ask the user whether to allow the use of the UE information through a UI requesting permission from the user. For example, the UI of the UE 200 may display a notification window for agreement on UE information through a pop-up window in the UE 200, and the UI of the application may display a notification window for agreement on UE information, upon execution of the application.

When the user allows the application or application server 240 to use the UE information or when the UE 200 identifies pre-stored permission for use of the UE information, the UE 200 may generate an encryption key for privacy verification using K_AUSF which the UE 200 has generated after successful completion of the primary authentication with the network, so that the application or application server 240 may identify that it has obtained permission for use of the UE information from the encryption key for privacy verification. Subsequently, the UE 200 may generate a token indicating permission for use of the UE information using the encryption key for privacy verification at S212. The encryption key for privacy verification may also be generated by the AUSF 210.

When generating the token, the UE 200 may include, in the token, privacy permission information that may indicate permission for use of the UE information, and information signed with the encryption key for privacy verification to enable the privacy permission information to be identified as correct information generated from the UE 200. The privacy permission information may include information about an identifier (ID) of the application requesting use of the UE information or an ID of the application server. The privacy permission information may further include an information indication indicating the type and form of the UE information and specific UE information, and information indicating a use purpose of the UE information. In addition, the privacy permission information may include information such as a UE ID of the UE, an encryption key ID identifying the encryption key generated during the primary authentication, agreed on with the mobile communication system, or an encryption key ID identifying the encryption key for privacy verification. The UE 200 may set and include a valid duration of the token in the token. Information about the UE ID or the encryption key ID identifying the encryption key such as K_AUSF agreed on with the network may be transmitted together with the token.

To sign the privacy permission information with the encryption key for privacy verification, the UE 200 may generate a predefined hash value by applying a hash algorithm preset between the UE 200 and the network. When applying the hash algorithm, the UE 200 may use the encryption key for privacy verification together with an input value.

The UE 200 may transmit a use permission message including the generated token and information about permission for the use of the UE information to the application or application server 240 at S214. Upon receipt of the information about permission for use of the UE information, the application may transmit the received information to the application server 240. Herein, the UE 200 may transmit information such as the UE ID of the UE or the encryption key ID identifying the encryption key K_AUSF agreed on with the network in addition to the token by the use permission message.

The application or application server 240 may transmit the permission for use of the UE information to the network, including the received token, and request the required UE information. The application or application server 240 may transmit a message requesting the UE information, including the token to the NEF 230 at S216. When the application or application server 240 is included in the network, the application or application server 240 may directly request the UE information from an NF having the UE information, not the NEF 230.

Upon receipt of the UE information request from the application or application server 240, the NEF 230 may transmit, to the AUSF 210, the request for permission for use of the UE information included in the UE information request, or the token and information such as the UE ID of the UE or the encryption key ID identifying the encryption key K_AUSF of the UE, to request verification of the authenticity or validity of the token at S218. When the application or the application server 240 directly requests the UE information from the NF 220, the NF 220 may request the AUSF 210 to verify the authenticity or validity of the token.

The AUSF 210 may identify the UE 200 that has generated the token, using the received token, information such as the UE ID or the encryption key ID identifying the encryption key of the UE, and an ID of the application or application server 240, and verify whether the token included in the request for using the UE information is valid, using the encryption key K_AUSF of the UE shared with the UE 200 and the encryption key for privacy verification.

In a token verification method according to an embodiment, the AUSF 210 may generate the encryption key for privacy verification generated by the UE 200, using the same encryption key K_AUSF as generated by the UE 200 or the encryption key K_AUSF having the same information as generated by the UE after success of the primary authentication of the UE, generate a signature for the privacy permission information included in the token, using the encryption key for privacy verification, and compare the generated signature with the signature included in the UE information request to identify whether the signatures match.

When the AUSF 210 fails in generating the same signature as the signature included in the UE information request, the AUSF 210 may reject the UE information request, considering that the UE information request of the application or application server 240 has been changed without permission, or the encryption key for privacy verification used for the signature is incorrect.

The AUSF 210 may verify whether the token included in the received UE information request is correct. Upon completion of successful verification of the validity of the token, the AUSF 210 may reply to the NEF 230 with a message indicating that the token has been verified. When the application or application server 240 is included in the network, the AUSF 210 may reply to the NF 220 with the message indicating that the token has been verified.

After identifying that the token is verified as correct, the NEF 230 may request and receive the UE information requested by the application or the application server 240 from the NF 220 having the UE information at S220.

Upon receipt of the requested UE information from the NF 220, the NEF 230 may provide the received UE information to the application or application server 240 at S222. When the application or application server 240 is included in the network system, the NF 220 may directly provide the requested UE information to the application or application server 240.

According to an embodiment, in the case where the token includes the validity duration of the token, only when the token is verified as correct, and the valid duration of the token has not expired, an NF such as a UDM or the NEF 230 may consider that the token is correct and transmit the requested UE information included in the UE information request to the application or the application server 240.

In addition, the NEF 230 may provide only information within a requested range to the application or application server 240, referring to the information indication indicating the type and form of the UE information and the specific UE information, and the information indicating the use purpose of the UE information, included in the token.

In an embodiment, the NEF 230 may refer to an information indication indicating the type and form of UE information allowed to be provided by the UE 200 and specific UE information, and information indicating a use purpose of the UE information, among information about the UE 200 stored in the network (e.g., the UDM) before the AUSF 210 completely verifies the token or is requested to verify the token. When the range of the UE information included in the received UE information request is outside an allowed range stored in the NF 220 such as the UDM, the NEF 230 may reject the request. Alternatively, after the verification of the token is completed, the NEF 230 may provide only UE information within the allowed range to the application or application server 240.

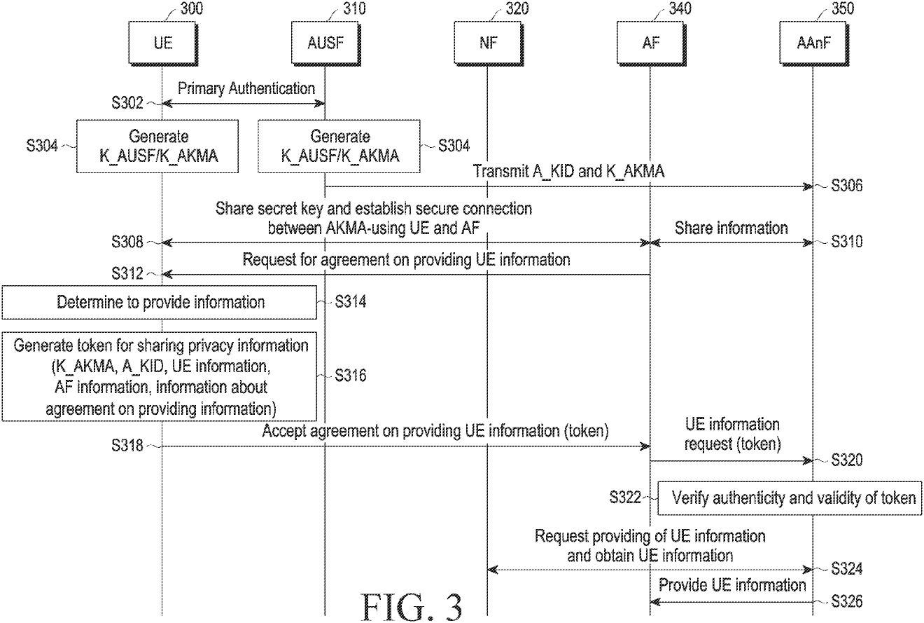

FIG. 3 illustrates a signal flow for a procedure of obtaining UE information, using a token in a network supporting an AKMA function, according to an embodiment.

As illustrated in FIG. 3, when a UE 300 successfully completes authentication with a network, and the UE 300 and the network support the AKMA function, the UE 300 generates an AKMA encryption key, K_AKMA, using an encryption key K_AUSF shared with an AUSF 310. The UE 300 and an AAnF 350 share the same AKMA encryption key and an ID A_KID identifying the AKMA encryption key generated by the UE 300, and share a privacy encryption key generated by the UE 300. The UE 300 generates a token by which to verify whether the UE 300 has allowed an AF 340 to use UE information when the AF 340 requests the UE information from the network (the NF 320), using the shared privacy encryption key. Upon receipt of the token, the AF 340 attaches the token to a request for required UE information from the network 320, and the network 320 requests the AAnF 350 to verify the validity of the token. After verifying whether the token is correct, the network 320 provides the UE information requested by the AF 340 to the AF 340.

The UE 300 performs a registration procedure for accessing the network in the mobile communication system. Herein, the AUSF 310 and the UE 300 perform a primary authentication procedure for authenticating to the network at S302. After succeeding in the primary authentication, the UE 300 and the AUSF 310 responsible for authentication in the network may generate the same encryption key, K_AUSF to be used later for security of the UE at S304.

Further, when the UE 300 and the network system support AKMA, the UE 300 and the AUSF 310 may generate the AKMA encryption key K_AKMA using the generated encryption key K_AUSF, and the AUSF 310 may transmit K_AKMA and the ID A_KID of K_AKMA of the UE 300 to the AAnF 350 (at S306.

After receiving K_AKMA and A_KID from the AUSF 310, the AAnF 350 may generate an encryption key for privacy verification of the UE 300, and generate and store an encryption key ID identifying the generated encryption key for privacy verification.

The UE 300 may connect to the application or application server 340 to provide a service to a user. The UE 300 and the application server 340 may be connected to each other, using a mobile communication system or another communication system. The UE 300 and the application server 340 may connect a session through a 3GPP or non-3GPP network.

At S308, when the UE 300 and the network system support the AKMA function, the UE 300 and the application or application server 340 may configure and share a secret key, and establish a secure connection to protect data transmission and reception between them.

The application or application server 340 may share information (e.g., K_AKMA, A_KID, and so on) received from the UE 300, and an ID of the application or application server 340 with the AAnF 350 at S310. When the application or application server 340 requires UE information to provide a service, it may request permission for use of the UE information from the UE 300. When the application or application server 340 needs UE information that the network has, it may request permission for use of UE information, inclusive of the UE information that the network has at S312.

Upon receipt of the request for permission for use of the UE information from the application or application server 340, the UE 300 may determine whether to allow use of the requested information at S314. The UE 300 may use information about permission or non-permission that has been received from the user and stored to determine whether to allow use of the UE information. Alternatively, when the UE 300 needs to obtain permission for use of the UE information from the user, the UE 300 may ask the user whether to allow the use of the UE information. In this case, the UE 300 may ask the user whether to allow the use of the UE information, using a UI of the UE 300 or through a UI of the application.

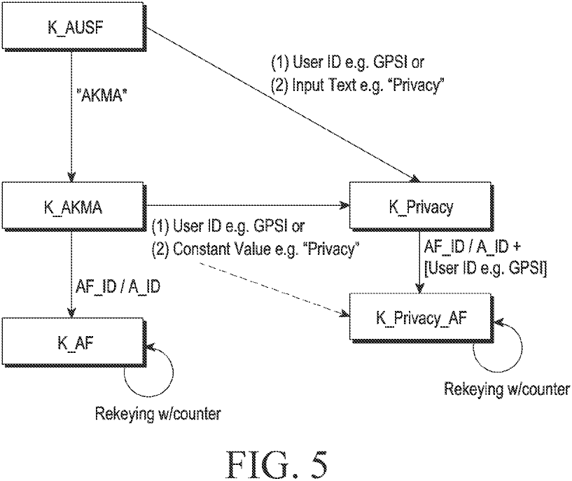

When the user allows the application or application server 340 to use the UE information or when the UE 300 identifies pre-stored permission for use of the UE information, the UE 300 may generate an encryption key for privacy verification using the encryption key K_AKMA shared with the network, so that the application or application server 340 may identify that it has obtained permission for use of the UE information from the encryption key for privacy verification. A method of generating the encryption key for privacy verification will be described later with reference to FIG. 5. Subsequently, the UE 300 may generate a token indicating permission for use of the UE information using the encryption key for privacy verification at S316.

When generating the token, the UE 300 may include, in the token, privacy permission information that may indicate permission for use of the UE information, and information signed with the encryption key for privacy verification to enable the privacy permission information to be identified as correct information generated from the UE 300. The privacy permission information may include information about an ID of the application requesting use of the UE information or an ID of or the application server. The privacy permission information may further include an information indication indicating the type and form of the UE information and specific UE information, and information indicating a use purpose of the UE information. In addition, information such as the UE ID, the encryption key ID A_KID identifying the encryption key K_AKMA determined with the network, or an encryption key ID identifying the encryption key for privacy verification may also be included in the privacy permission information and transmitted together with the token. The information such as the UE ID or the encryption key IDs identifying the encryption keys agreed on with the network may also be delivered to a receiver, when the token is transmitted.

To sign the privacy permission information with the encryption key for privacy verification, the UE 300 may generate a predefined hash value by applying a hash algorithm preset between the UE 300 and the network. When applying the hash algorithm, the UE 300 may use the encryption key for privacy verification together with an input value.

The UE 300 may transmit a use permission message including the generated token and information about permission for the use of the UE information to the application or application server 340 at S318. Upon receipt of the use permission message including the token from the UE 300, the application may transmit the received message to the application server. Herein, the UE 300 may transmit the information such as the UE ID or the encryption key ID identifying the encryption key agreed on with the network in addition to the token.

The application or application server 340 may transmit a UE information request including the received token to the AAnF 350, requesting the required UE information at S320.

Upon receipt of the UE information request from the application or application server 340, the AAnF 350 may identify the UE 300 which has generated the token, using the token included in the UE information request and information such as the UE ID identifying the UE, A_KID identifying the encryption key K_AKMA of the UE, and the encryption key ID identifying the encryption key for privacy verification, and verify whether the token included in the UE information request is correct, using the AKMA encryption key K_AKMA and the encryption key for privacy verification which are shared with the UE at S322.

At S322, in a token verification method according to an embodiment, the AAnF 350 may generate the encryption key for privacy verification generated by the UE 300, using the same encryption key K_AKMA as generated by the UE 300 or the encryption key K_AKMA having the same information as generated by the UE through sharing, generate a signature for the privacy permission information included in the token, using the encryption key for privacy verification, and compare the generated signature with the signature included in the UE information request to identify whether the signatures match.

When the AAnF 350 fails in generating the same signature as the signature included in the UE information request, the AAnF 350 may reject the UE information request, considering that the UE information request of the application or application server 340 has been changed without permission, or the encryption key for privacy verification used for the signature is incorrect.

The AAnF 350 may verify whether the token included in the received UE information request is correct. Upon completion of successful verification of the validity of the token, the AAnF 350 may directly provide the requested UE information to the application or application server 340, when the AAnF 350 stores the UE information. When the AAnF 350 does not store the UE information, the AAnF 350 may request and receive the UE information required by the application or application server 340 from the NF 320 at S324. Upon receipt of the UE information from the NF 320, the AAnF 350 may provide the requested UE information to the application or application server 340 at S326.

In the case where the token includes a validity duration of the token, only when the token is verified as correct, and the valid duration of the token has not expired, the AAnF 350 may consider that the token is correct and transmit the UE information included in the UE information request to the application or the application server 340.

In addition, the AAnF 350 may provide only information within a requested range to the application or application server 340, referring to the information indication indicating the type and form of the UE information and the specific UE information, and the information indicating the use purpose of the UE information, included in the token.

In an embodiment, the AAnF 350 may refer to an information indication indicating the type and form of UE information allowed to be provided by the UE 300 and specific UE information, and information indicating a use purpose of the UE information, among information about the UE 300 stored in a UDM after or before the token is verified. When the range of the UE information included in the received UE information request is outside an allowed range stored in the NF 320 such as the UDM, the AAnF 350 may reject the request. Alternatively, after the verification of the token is completed, the AAnF 350 may provide only UE information within the allowed range to the application or application server 340.

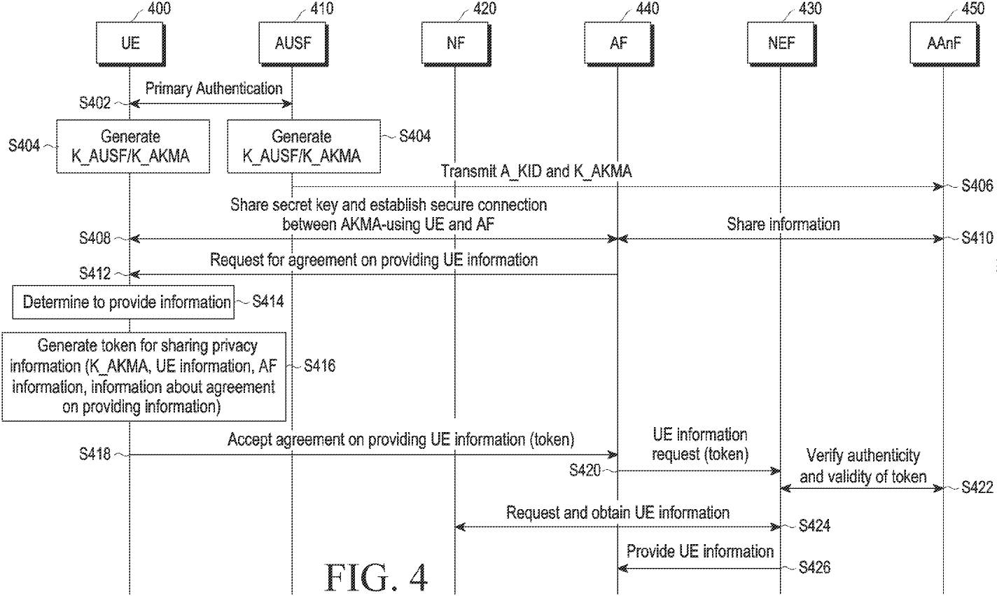

FIG. 4 illustrates a signal flow for a procedure of obtaining UE information, using a token in a network supporting an AKMA function, according to an embodiment.

In FIG. 4, a UE 400 may issue a token to an AF 440 based on the AKMA function, and the AF 440 that has received the token may obtain UE information through communication with an NEF 430.

As illustrated in FIG. 4, when the UE 400 successfully completes authentication with a network, and the UE 400 and the network support the AKMA function, the UE 400 generates an AKMA encryption key, K_AKMA, using an encryption key K_AUSF shared with an AUSF 410. The UE 400 and an AAnF 450 share the same AKMA encryption key K _AKMA and an ID A_KID identifying the AKMA encryption key of the UE 400, and share a privacy encryption key generated by the UE 400. The UE 400 generates a token by which to verify whether the UE 400 has allowed an AF 440 to use UE information when the AF 440 requests the UE information from the network (an NEF 430), using the shared privacy encryption key. Upon receipt of the token, the AF 440 attaches the token to a request for required UE information from the NEF 430, and the NEF 430 requests the AAnF 450 to verify the validity of the token. After verifying whether the token is correct, the NEF 430 provides the UE information requested by the AF 440 to the AF 440.

The UE 400 performs a registration procedure for accessing the network in the mobile communication system. Herein, the UE 400 performs a primary authentication procedure for authenticating to the network at S402. After succeeding in the primary authentication, the UE 400 and the AUSF 410 responsible for authentication in a network system may generate the same encryption key, K_AUSF to be used later for security of the UE at S404.

Further, when the UE 400 and the network system support the AKMA function, the UE 400 and the AUSF 410 may generate the AKMA encryption key K_AKMA using the generated encryption key K_AUSF, and the AUSF 410 may transmit K_AKMA and the ID A_KID of K_AKMA of the UE 400 to the AAnF 450 at S406.

After receiving K_AKMA and A_KID from the AUSF 410, the AAnF 450 may generate an encryption key for privacy verification of the UE 400, and generate and store an encryption key ID identifying the generated encryption key for privacy verification.

The UE 400 may connect to the application or application server 440 to provide a service to a user. The UE 400 and the application server 440 may be connected to each other, using a mobile communication system or another communication system. The UE 400 and the application server 440 may connect a session through a 3GPP or non-3GPP network.

At S408, when the UE 400 and the network system support the AKMA function, the UE 400 and the application or application server 440 may configure and share a secret key, and establish a secure connection to protect data transmission and reception between them.

The application or application server 440 may share information (e.g., K_AKMA, A_KID, and so on) received from the UE 400, and an ID of the application or application server 440 with the AAnF 450 at S410.

When the application or application server 440 requires UE information to provide a service, it may request permission for use of the UE information from the UE 400. When the application or application server 440 needs UE information that the network has, it may request permission for use of UE information, inclusive of the UE information that the network has at S412.

Upon receipt of the request for permission for use of the UE information from the application or application server 440, the UE 400 may determine whether to allow use of the requested information at S414. The UE 400 may use information about permission or non-permission that has been received from the user and stored to determine whether to allow use of the UE information. Alternatively, when the UE 400 needs to obtain permission for use of the UE information from the user, the UE 400 may ask the user whether to allow the use of the UE information. In this case, the UE 400 may ask the user whether to allow the use of the UE information, using a UI of the UE 400 or through a UI of the application.

When the user allows the application or application server 440 to use the UE information or when the UE 400 identifies pre-stored permission for use of the UE information, the UE 400 may generate an encryption key for privacy verification using the encryption key K_AKMA shared with the network, so that the application or application server 440 may identify that it has obtained permission for use of the UE information from the encryption key for privacy verification. Subsequently, the UE 400 may generate a token indicating permission for use of the UE information using the encryption key for privacy verification at S416.

When generating the token, the UE 400 may include, in the token, privacy permission information that may indicate permission for use of the UE information, and information signed with the encryption key for privacy verification to enable the privacy permission information to be identified as correct information generated from the UE 400. The privacy permission information may include information about an ID of the application requesting use of the UE information or an ID of or the application server. The privacy permission information may further include an information indication indicating the type and form of the UE information and specific UE information, and information indicating a use purpose of the UE information. In addition, information such as the UE ID, the encryption key ID A_KID identifying the encryption key K_AKMA determined with the network, or an encryption key ID identifying the encryption key for privacy verification may also be included in the privacy permission information and transmitted together with the token. The information such as the UE ID or the encryption key IDs identifying the encryption keys agreed on with the network may also be delivered to a receiver, when the token is transmitted.

To sign the privacy permission information with the encryption key for privacy verification, the UE 400 may generate a predefined hash value by applying a hash algorithm preset between the UE 400 and the network. When applying the hash algorithm, the UE 400 may use the encryption key for privacy verification together with an input value.

The UE 400 may transmit a use permission message including the generated token and information about permission for the use of the UE information to the application or application server 440 at S418. Upon receipt of the use permission message including the token from the UE 400, the application may transmit the received message to the application server. Herein, the UE 400 may transmit the information such as the UE ID or the encryption key ID identifying the encryption key agreed on with the network in addition to the token.

The application or application server 440 may transmit a UE information request including the received token to the NEF 430, requesting the required UE information at S420.

Upon receipt of the UE information request from the application or application server 440, the NEF 430 may forward the UE information request to the AAnF 450 or transmit the token included in the UE information request, and information such as the UE ID identifying the UE, A_KID identifying K_AKMA of the UE, or the encryption key ID identifying the encryption key for privacy verification of the UE to the AAnF 450, to request verification of the token at S422.

Upon receipt of the request for verification of the token from the NEF 430, the AAnF 450 may identify the UE 400 which has generated the token, using the token included in the UE information request and information such as the UE ID identifying the UE, A_KID identifying the encryption key K_AKMA of the UE, and the encryption key ID identifying the encryption key for privacy verification, and verify whether the token included in the UE information request is correct, using the AKMA encryption key K_AKMA and the encryption key for privacy verification which are shared with the UE.

At S422, in a token verification method according to an embodiment, the AAnF 450 may generate the encryption key for privacy verification generated by the UE 400, using the same encryption key K_AKMA as generated by the UE 400 or the encryption key K_AKMA having the same information as generated by the UE through sharing, generate a signature for the privacy permission information included in the token, using the encryption key for privacy verification, and compare the generated signature with the signature included in the UE information request to identify whether the signatures match.

When the AAnF 450 fails in generating the same signature as the signature included in the UE information request, the AAnF 450 may reject the UE information request, considering that the UE information request of the application or application server 440 has been changed without permission, or the encryption key for privacy verification used for the signature is incorrect.

The AAnF 450 may verify whether the token included in the received UE information request is correct. Upon completion of successful verification of the validity of the token, the AAnF 450 may notify the NEF 430 of a result of verifying the token included in the UE information request at S422.

When identifying that the token has been verified as correct, the NEF 430 may request and receive the UE information requested by the application or application server 440 from the NF 420 having the UE information at S424.

Upon receipt of the requested UE information from the NF 420, the NEF 430 may provide the received UE information to the application or application server 440 at S426. When the application or application server 440 is included in the network system, the NF 420 may directly provide the requested UE information to the application or application server 440.

In the case where the token includes a validity duration of the token, only when the token is verified as correct, and the valid duration of the token has not expired, a network device such as the NEF 430 may consider that the token is correct and transmit the UE information included in the UE information request to the application or the application server 440.

In addition, the NEF 430 may provide only information within a requested range to the application or application server 440, referring to the information indication indicating the type and form of the UE information and the specific UE information, and the information indicating the use purpose of the UE information, included in the token.

The AAnF 450 or the NEF 430 may refer to an information indication the type and form of UE information allowed to be provided by the UE 400 and indicating specific UE information, and information indicating a use purpose of the UE information, among information about the UE 400 stored in a UDM after or before the token is verified. When the range of the UE information included in the received UE information request is outside an allowed range stored in the NF 420 such as the UDM, the AAnF 450 or the NEF 430 may reject the request. Alternatively, after the verification of the token is completed, the AAnF 450 or the NEF 430 may provide only UE information within the allowed range to the application or application server 440.

FIG. 5 illustrates a method of generating an encryption key used to manage privacy of a UE according to an embodiment.

To generate an encryption key for privacy verification, K_Privacy_AF from an encryption key K_AUSF shared between a UE and an AUSF, the UE or the AUSF may generate an encryption key K _Privacy_for use in generating the encryption key for privacy verification, K_Privacy_AF by inputting K_AUSF, and a UE ID of the UE such as a generic public subscription identifier (GPSI) or a constant indicating a certain input value, for example, a fixed text string such as “Privacy” into a key derivation function agreed between the UE and the network system.

To generate the encryption key for privacy verification, K_Privacy_AF using the generated K_Privacy, the UE and the AUSF may set an input value for generating the encryption key for privacy verification, including information about an application server ID identifying an application server, an application ID identifying a related application, or the UE ID of the UE such as the GPSI, and input the input value into the key derivation function agreed between the UE and the AUSF. Thus, the encryption key for privacy verification, K_Privacy_AF, may be generated.

In addition, when generating K_Privacy_AF, the UE and the AUSF may set a valid duration for period-based management according to the period. When an encryption key for privacy verification is to be regenerated according to the valid duration, a variable for configuring counter information or another input value for generating a new K_Privacy_AF may be defined and used for generating the new K Privacy_AF different from the old K_Privacy_AF. In this case, regarding the variable for configuring a counter or another input value, an input method or an input value may be predetermined or shared between the UE and the AUSF so that a different input value may be input whenever K_Privacy_AF is generated.

According to another embodiment, when the UE and the network support the AKMA function, the encryption key for privacy verification may be generated using K_AKMA. In a method of generating K_AKMA, K_AUSF shared between the UE and the network and a constant indicating a constant input value may be input into the key derivation function mutually agreed in the network system. For example, K_AKMA may be generated by inputting a text string “AKMA” into any key derivation function. When generating the encryption key for privacy verification, K _Privacy_AF using the AKMA function, the UE or an AAnF may generate the encryption key K _Privacy_for use in generating the encryption key for privacy verification, K_Privacy_AF by inputting K_AKMA, and the UE ID of the UE such as the GPSI or a constant indicating a certain input value, for example, a text string such as “Privacy” into a key derivation function agreed between the UE and the network system.

To generate the encryption key for privacy verification, K_Privacy_AF using the generated K_Privacy, the UE and the AAnF may set an input value for generating the encryption key for privacy verification, including information about the application server ID identifying the application server, the application ID identifying the related application, or the UE ID of the UE such as the GPSI, and input the input value into a key derivation function agreed between the UE and the AAnF. Thus, the encryption key for privacy verification, K_Privacy_AF, may be generated. The UE and the AAnF may directly generate K_Privacy_AF using K_AKMA, without generating K_Privacy. The UE and the AAnF may generate K_Privacy_AF using K_AKMA, the UE ID, the constant indicating the certain input value, or the ID of the application or application server.

In addition, when generating K_Privacy_AF, the UE and the AUSF may set a valid duration for period-based management according to the period. When an encryption key for privacy verification is to be regenerated according to the valid duration, a variable for configuring counter information or another input value for generating a new K_Privacy_AF may be defined and used for generating the new K Privacy_AF different from the old K_Privacy_AF. In this case, a variable for configuring a counter or another input value may be predetermined between the UE and the AAnF, or a variable for configuring an input or an input value may be pre-shared between the UE and the application server (or application) and between the application server and the AAnF, or between the application server and an NEF and between the NEF and the AAnF through connections and message transfer.

The UE and the AAnF may generate K_AF using K_AKMA. K_AF may be an encryption key for use in the application or application server. K_AF may be a key used for security between the application or application server and the UE. The UE and the AAnF may generate K_AF by inputting K_AKMA and the ID of the application or application server into any key derivation function.

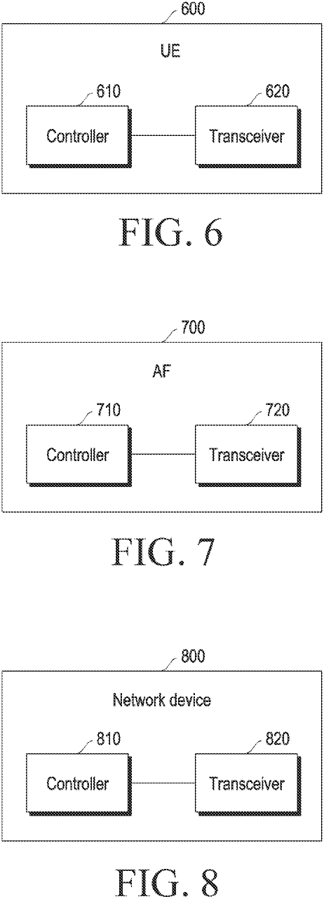

FIG. 6 illustrates a structure of a UE according to an embodiment. As illustrated in FIG. 6, the UE 600 may include at least one controller (or processor) 610 and a transceiver 620 including a receiver and a transmitter. The UE may also include memory. The transceiver 620 and the memory may be connected to the at least one controller 610 to operate under the control of the at least one controller 610.

The at least one controller 610 may control a series of processes so that the operations of the UE 600 described herein may be performed. The transceiver 620 may transmit and receive signals to and from an AF 700 and a network 800. The signal may include control information and data.

FIG. 7 illustrates a structure of an AF according to an embodiment. The AF 700 may conceptually include an application or an application server. As illustrated in FIG. 7, the AF 700 may include at least one controller (processor) 710 and a transceiver 720 including a receiver and a transmitter. The AF may also include memory. The transceiver 720 and the memory may be connected to the at least one controller 710 to operate under the control of the at least one controller 710.

The at least one controller 710 may control a series of processes so that the operations of the AF 700 described herein may be performed. The transceiver 720 may transmit and receive signals to and from the UE 600 and the network 800. The signal may include control information and data.

FIG. 8 illustrates a structure of a network device according to an embodiment. As illustrated in FIG. 8, the network device 800 may include at least one controller (processor) 810 and a transceiver 820 including a receiver and a transmitter. The network device may also include memory. The transceiver 820 and the memory may be connected to the at least one controller 810 to operate under the control of the at least one controller 810.

The at least one controller 810 may control a series of processes so that the operations of the network device described herein may be performed. The transceiver 820 may transmit and receive signals to and from the UE 600 and the AF 700. The signal may include control information and data.

The network device 800 may include all devices corresponding to NFs such as an AUSF, an NEF, an NF, a UDM, an AMF, a UPF, an SMF, an NRF, and a PCF, and each NF may be configured independently.

The embodiments of the disclosure disclosed in this Specification and the drawings are only presented as specific examples to easily explain the technical content of the disclosure and to help in the understanding of the disclosure, and are not intended to limit the scope of the disclosure. That is, it will be apparent to those skilled in the art that other modifications can be made based on the technical spirit of the disclosure. In addition, each of the above embodiments may be operated in combination with others as needed.

While the disclosure has been particularly shown and described with reference to certain embodiments thereof, it will be understood by those of ordinary skill in the art that various changes in form and details may be made therein without departing from the spirit and scope of the disclosure as defined by the following claims and their equivalents.

What is claimed is:

1. A user equipment (UE) in a wireless communication system, comprising:
a transceiver; and
at least one controller configured to:
configure a first encryption key with a network according to a primary authentication procedure;
receive a first message requesting permission for use of information about the UE from an application function device;
determine whether to allow use of the information about the UE based on reception of the message;
generate a token based on at least one of the first encryption key, an identifier (ID) of the UE, or a first input value based on determining to allow use of the information about the UE; and
transmit a second message indicating permission for use of the information about the UE, including the token to the application function device in response to the first message.

2. The UE of claim 1, wherein the token includes at least one of information related to the first encryption key, an ID identifying the first encryption key, information related to the ID of the UE, information indicating permission for use of the information about the UE, or a valid duration of the token.

3. The UE of claim 1, wherein the token includes information related to a use purpose, a type, or an allowed range of the information about the UE.

4. The UE of claim 1, wherein the at least one controller is further configured to display an interface of the UE requesting agreement on permission of use of the information about the UE on the UE or request display of an interface of an application requesting agreement on permission of use of the information about the UE.

5. The UE of claim 1, wherein in case that the UE supports an authentication and key management for applications (AKMA) function, the token is generated based on at least one of a second encryption key generated based on the first encryption key and a second input value, the ID of the UE, or the first input value.

6. An application function device in a wireless communication system, comprising:
a transceiver; and
at least one controller configured to:
transmit a first message requesting permission for use of information about a user equipment (UE) to the UE; and
receive a second message indicating permission for use of the information about the UE, including a token from the UE in response to the first message,
wherein the token is generated based on at least one of a first encryption key, an identifier (ID) of the UE, or a first input value.

7. The application function device of claim 6, wherein the at least one controller is further configured to:
transmit a third message requesting information about the UE including the token to a network device; and
receive the information about the UE from the network device, based on the token being determined as valid by the network device.

8. The application function device of claim 7, wherein the information about the UE is determined based on at least one of the information requested by the application function device or information related to a use purpose, a type, or an allowed range of the information about the UE, included in the second message indicating permission for use of the information about the UE.

9. The application function device of claim 6, wherein the token includes at least one of information related to the first encryption key, an ID identifying the first encryption key, information related to the ID of the UE, information indicating permission for use of the information about the UE, a valid duration of the token, or information related to a use purpose, a type, or an allowed range of the information about the UE.

10. The application function device of claim 6, wherein the at least one controller is further configured to:
receive a fourth message requesting use of an interface of an application from the UE; and
display an interface of the application requesting agreement on permission for use of the information about the UE in response to the fourth message.

11. A network device in a wireless communication system, comprising:
a transceiver; and
at least one controller configured to:
receive a first message requesting information about a user equipment (UE), including a token from an application function device;
determine whether the token is valid based on at least one of a first encryption key, an identifier (ID) of the UE, or a first input value; and
transmit the information about the UE requested by the application function device to the application function device, based on determining the token as valid.

12. The network device of claim 11, wherein the token includes at least one of information related to the first encryption key, an ID identifying the first encryption key, information related to the ID of the UE, information indicating permission for use of the information about the UE, a valid duration of the token, or information related to a use purpose, a type, or an allowed range of the information about the UE.

13. The network device of claim 11, wherein the information about the UE is determined based on at least one of the information requested by the application function device, or information related to a use purpose, a type, or an allowed range of the information about the UE, included in a second message indicating permission for use of the information about the UE.

14. The network device of claim 11, wherein the at least one controller is further configured to:
generate a second encryption key based on at least one of the first encryption key, the ID of the UE, or the first input value; and
determine that the token is valid by comparing the second encryption key with the token.

15. The network device of claim 11, wherein when the network device supports an authentication and key management for applications (AKMA) function, the token is generated based on at least one of a third encryption key generated based on the first encryption key and a second input value, the ID of the UE, or the first input value.

16. A method performed by a user equipment (UE) in a wireless communication system, comprising:
configuring a first encryption key with a network according to a primary authentication procedure;
receiving a first message requesting permission for use of information about the UE from an application function device;
determining whether to allow use of the information about the UE based on reception of the message;
generating a token based on at least one of the first encryption key, an identifier (ID) of the UE, or a first input value based on determining to allow use of the information about the UE; and
transmitting a second message indicating permission for use of the information about the UE, including the token to the application function device in response to the first message.

17. The method of claim 16, wherein the token includes at least one of information related to the first encryption key, an ID identifying the first encryption key, information related to the ID of the UE, information indicating permission for use of the information about the UE, or a valid duration of the token.

18. The method of claim 16, wherein the token includes information related to a use purpose, a type, or an allowed range of the information about the UE.

19. The method of claim 16, further comprising:
displaying an interface of the UE requesting agreement on permission of use of the information about the UE on the UE or request display of an interface of an application requesting agreement on permission of use of the information about the UE.

20. The method of claim 16, wherein in case that the UE supports an authentication and key management for applications (AKMA) function, the token is generated based on at least one of a second encryption key generated based on the first encryption key and a second input value, the ID of the UE, or the first input value.
